(19) United States
(12) Patent Application Publication
(10) Pub. No.: US 2008/0270212 A1
(43) Pub. Date: Oct. 30, 2008

(54) METHOD, APPARATUS OR SOFTWARE FOR MANAGING A DATA PROCESSING PROCESS

(76) Inventors: JEFFREY BLIGHT, Windsor (GB); Amanda Elizabeth Chessell, Alton (GB); Martin J. Gale, Eastleigh (GB); Christopher Edward Sharp, Winchester (GB)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 11/739,706

(22) Filed: Apr. 25, 2007

(51) Int. Cl. G06F 9/50

(52) U.S. Cl. 705/8

(57) ABSTRACT

A method, apparatus and software is disclosed for managing a data processing process in the form of a workflow, where activities in the workflow can use services or sub-processes to complete their task. A policy is associated with such activities to indicate how the data processing process should manage the situation where an activity's performance is not acceptable. This includes a policy for replacing or substituting the service or sub-process.

### FIELD OF INVENTION

The present invention relates to a method, apparatus and program product for managing a data processing process.

### BACKGROUND OF THE INVENTION

Data processing systems commonly carry out data processing processes, which comprise a sequence of activities. Each activity has an implementation in the form of local code, a service such as a web service or another process in its own right, referred to as a sub-process. The correct operation of an implementation of a given activity combined with the appropriate management of the interaction between activities is important for the successful operation of the data processing process as a whole. The management of the overall process and of the operation of each sub-process is carried out by a management system. An example of such a management system is a workflow application program. Such applications enable workflows to be set up which define a sequence of activities for achieving a given overall process. Each workflow is de fined using a process definition language. Workflow applications read the workflow definitions and manage an instance of the workflow so that required data is automatically passed between each activity when appropriate.

In order to ensure that the data processing process is carried out within desired limits, one or more sets of performance criteria can be defined. These performance criteria, which may be in the form of one or more policies, are used by the management system to measure the performance of the process as a whole or that of its activities. The activities themselves may call further sub-processes or services to perform particular elements of their processing.

US 2005/0010456 A1 discloses a system for managing a data processing process in which the performance of the process relative to a policy is monitored using probe points which provide performance data from predefined locations in the process. The performance data collected from the probe points is compared to performance thresholds called Key Performance Indicators (KPIs). KPIs are defined in the policy for the process and thus used to determine if the process is being performed as required. However, with this system, although any departure in the performance of a data processing process from the policy can be detected, there is no mechanism for automatically correcting the performance failure.

### SUMMARY OF THE INVENTION

A workflow process comprising one or more activities is managed in a series of operations. Initially, a workflow definition is created that defines a sequence of activities that comprise a workflow process. A first activity implementation is identified for providing services to one or more of the activities and assigning the first activity implementation to a first activity. A set of one or more performance criteria is associated for the performance of the first activity implementation when providing service to the first activity. The performance of the first activity implementation is monitored against the set of performance criteria. A second activity implementation is identified for providing services to the first activity. If the first activity implementation fails to meet one or more of the performance criteria, then the second activity implementation is assigned to the first activity in place of the first activity implementation.

### BRIEF DESCRIPTION OF THE DRAWINGS

Embodiments of the invention will now be described, by way of example only, with reference to the accompanying drawings in which:

FIG. 1 is a schematic illustration of a computer system for processing data;

FIG. 2 is a flow chart illustrating a data processing process carried out by the computer system of FIG. 1;

FIG. 3 is a schematic illustration of a management system for managing the process of FIG. 2;

FIG. 4 is a flow chart illustrating processing carried out by the management system of FIG. 3; and

FIG. 5 is a flow chart illustrating processing carried out by another embodiment of the management system of FIG. 3.

### DETAILED DESCRIPTION

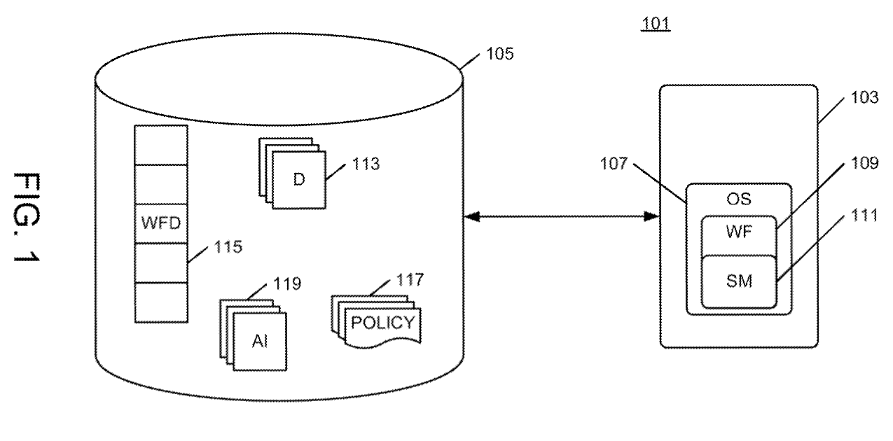

FIG. 1 shows a computer system 101 comprising a computer 103 connected to a storage device 105. The computer system is running an operating system 107 and a data processing management application in the form of a workflow application program 109. The workflow application program 109 comprises a performance management module 111. The workflow application program 109 is arranged to process a set of data 113 stored on the storage device 105 using a sequence of activities defined in a workflow definition (WFD) 115. The storage device 105 also contains a set of policies 117 and activity implementations 119 in the form of local code, web service access data and sub-process software.

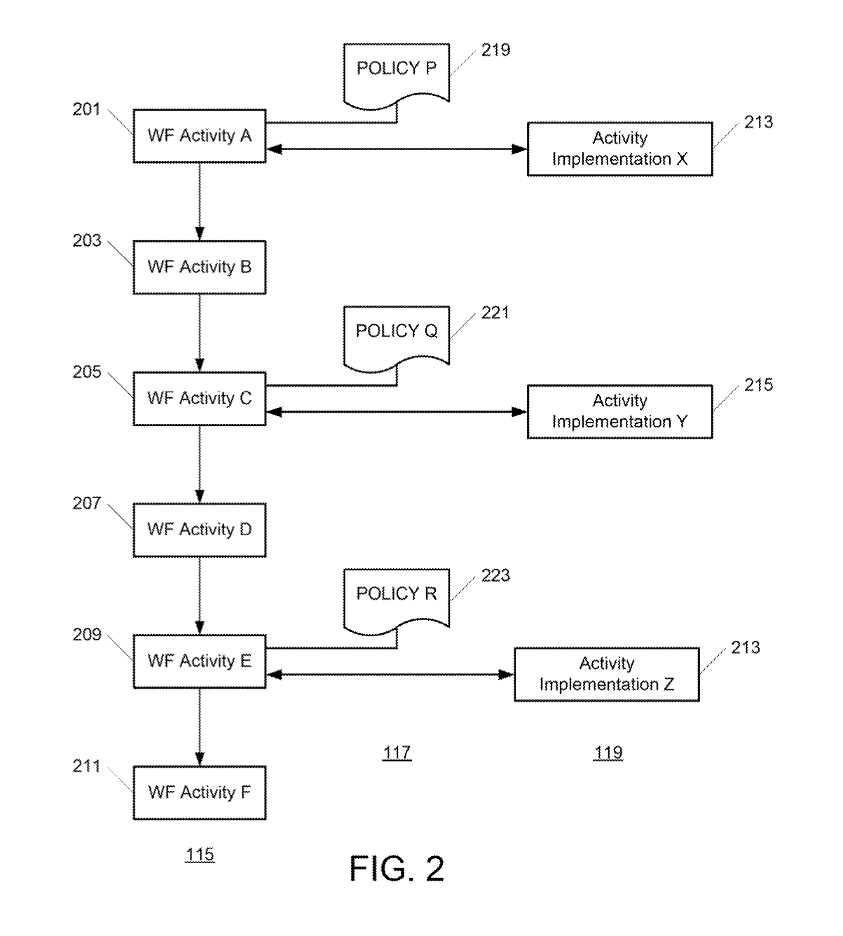

With reference to FIG. 2, the workflow definition 115 defines a set of activities 201-211 which run in sequence. In the example of FIG. 2, activities 201, 205, 209 each use an activity implementation in the form of sub-process software 213, 215 from the set of activity implementations 119 to provide function such as data retrieval or delivery. The workflow definition 115 defines which of the policies 117 apply to respective activity implementation 119 on an individual activity basis. In other words, each activity may be assigned to policy for the activity implementations that it makes use of. For example, activity 201 is associated in the workflow definition 115 with policy 219 for its use of sub-process 213, while activity 205 is associated with policy 221 for its use of sub-process 215. Furthermore, activity 209 is associated with policy 223 for its use of sub-process 213.

When an activity implementation provides services to a given activity in the workflow 115, its performance is monitored against any associated policy 117 by the performance management module 111. As noted above, the workflow definition 115 is used to define which policies 117 apply to any given activity/activity implementation pair. For example, the performance of sub-process software 213, when providing services to activity 201, is monitored against associated policy 219. The performance of sub-process software 215, when providing services to activity 205, is monitored against associated policy 221. However, the performance of sub-process software 213, when providing services to activity 209, is monitored against associated policy 223. In other words, activity implementations 119 can be monitored against different policy 117, depending on which activity in the workflow definition 115 an activity implementation 119 is providing services to.

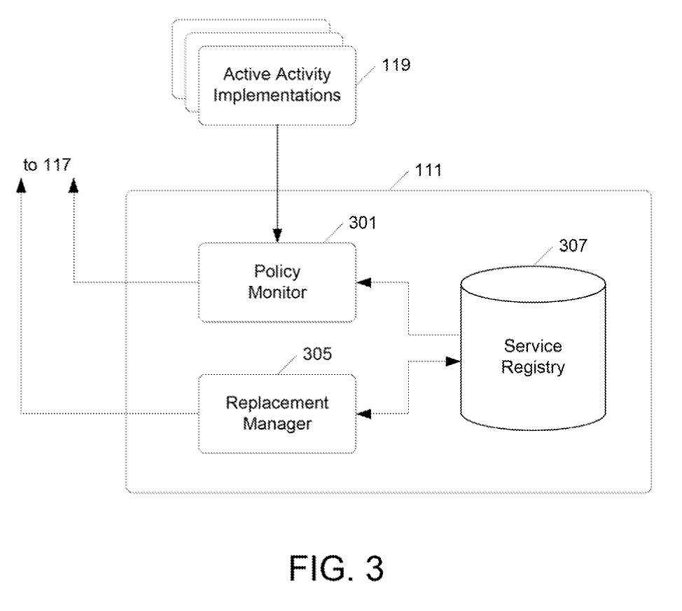

With reference to FIG. 3, the performance management module 111 comprises a performance monitor 301, a replacement manager 303 and a service registry 307. The processing of the performance monitor 301 is triggered when the processing of an instance of the workflow definition 115 by the workflow application program 109 results in the initiation of an activity implementation 119. In response to this trigger, the performance manager 301 identifies, from the workflow definition 115, any policy 117 associated with the initiated activity implementation 119. The performance of the initiated activity implementation is then monitored against the criteria contained in the identified policy 117. In the event that not all of the performance criteria are met, the performance monitor 301 passed the identity of the under-performing activity implementation 119 to the replacement manger 305. The replacement manager 305 consults the service registry 307, which contains an entry for each activity implementation 119. Each entry may identify alternative activity implementations 119 which may be substituted for any under-performing one. Once the replacement manage 305 has identified a substitute service process 119 from the registry 307, it updates the workflow definition 115 accordingly.

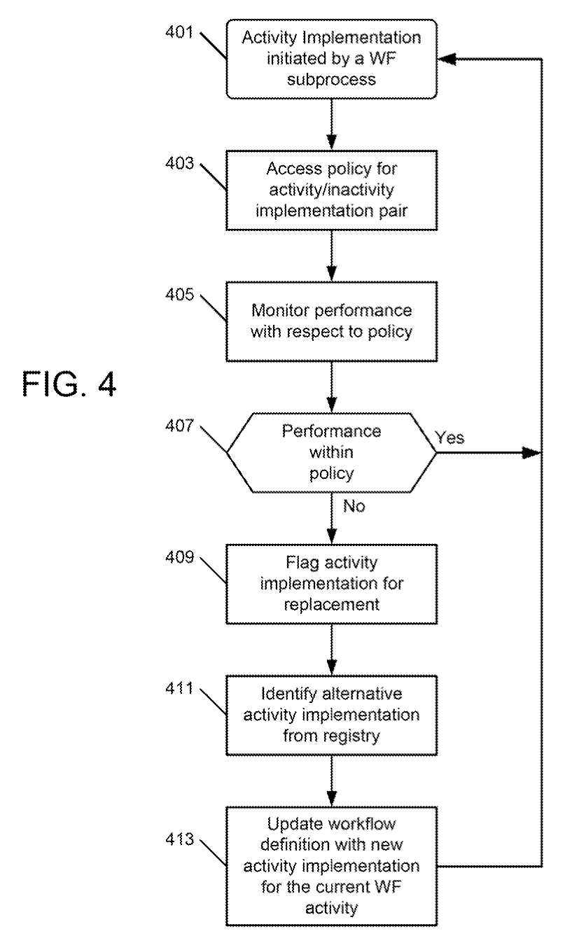

The processing carried out by the performance management module 111 during the operation of the workflow application program 109 will now be described further with reference to the flow chart of FIG. 4. At step 401, the initiation of an activity by the workflow application program 109 is detected and the relevant activity implementation 119 identified. Processing then moves to step 403 where the policy 117 associated in the workflow definition 115 with the initiated activity 119 is accessed and the relevant performance criteria identified. Processing then moves to step 405 where the performance of the activity implementation 119 is monitored with respect to the identified performance criteria. Once the activity implementation 119 has completed its processing, the processing moves to step 407 where the performance of the activity implantation 119 is compared to the performance criteria defined in the associated policy 117. If the performance meets or exceeds the performance criteria, then processing returns to step 401 to await the initiation of a further activity implementation 119. If, at step 407, the activity implementation 119 has failed to meet the required performance criteria, then processing moves to step 409.

At step 409, the activity implementation 119 is flagged for replacement for the given workflow activity and processing moves to step 411. At step 411, the service registry 307 is used to identify and alternative activity implementation 119. Processing the moves to step 413 where the workflow 115 is updated to substitute the alternative activity implementation 119 in place of the under-performing activity implementations 119 in the workflow definition 115 in relation to the activity for which under-performance was detected.

In a further embodiment, the replacement manager 305 is arranged to search for alternative activity implementations to provide substitutes when under-performance of an activity implementation is detected. The policy associated with an activity comprises criteria for the replacement of the activity implementation. The replacement criteria may include details of suitable sources or locations, which may be searched in order to identify suitable replacements. The replacement criteria may also define further criteria for the processing that any replacement activity implementation should perform.

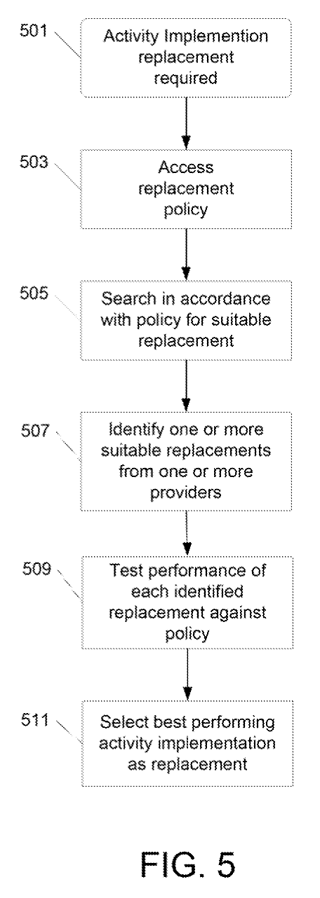

The processing carried out by the replacement manger 305 in this further embodiment will now be described with reference to the flow chart of FIG. 5. In step 501 the replacement manager detects that an activity implementation 119 requires replacing and processing moves to step 503. At step 503, the activity replacement elements of the associated policy are accessed and the replacement criteria identified. Processing then moves to step 505 where a search is conducted of the sources identified in the replacement criteria for substitute activity implementations. If, at step 507, one or more such activity implementations are identified, then processing moves to step 509. At step 509, the identified activity implementations are tested against the performance criteria in the policy. Once all the identified substitute activity implementations have been tested, then processing moves to step 511 where the best performing activity implementation is selected and the workflow definition 115 is updated accordingly.

In a further embodiment, a search for substitute activity implementations is initiated in response to the detection of under-performance of a current activity implementation. In another embodiment, substitute activity implementations are selected from a predetermined set of activity implementations provided by a range of service providers including third parties. In a further embodiment, the substitute activity implementations may not be actively tested prior to being utilized in the workflow.

In another embodiment, the search for substitute activity implementation is carried out as a tendering process in which third party service providers are invited to offer their activity implementations for use in the workflow. The tendering process may involve a message broker arranged to match offers from tendering service providers with a tender request issued by the replacement manager. In a further embodiment, the search for substitute activity implementations is carried out prior to under-performance of a current activity implementations being detected, in order to provide a list of one or more alternatives in the service registry 307. In another embodiment, when an activity implementations is replaced or substituted, it is substituted for all of the workflow activities which use it. In other words the substitution is global rather than local.

In the above embodiments, the policy may be used to identify alternative or substitute activity implementations or to determine whether or not substitution is possible. Some activity implementations may not have associated policies. In any of the above embodiments activity implementations may be provided by an combination of software subroutines, software library components or any other sub-process. The workflow may be processed by a single software application or a group of co-operating software applications. The workflow may be an automated or semi-automated set of activities.

It will be understood by those skilled in the art that the apparatus that embodies a part or all of the present invention may be a general purpose device having software arranged to provide a part or all of an embodiment of the invention. The device could be single device or a group of devices and the software could be single program or a set of programs. Furthermore, any or all of the software used to implement the invention can be communicated by any suitable transmission or storage means so that the software can be loaded onto one or more devices.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for managing a workflow process comprising one or more activities, said method comprising the steps of:
a) creating a workflow definition that defines a sequence of activities which comprise a workflow process;
b) identifying a first activity implementation for providing services to one or more of said activities and assigning said first activity implementation to a first said activity;
c) associating a set of one or more performance criteria for the performance of said first activity implementation when providing services to said first activity;
monitoring the performance of said first activity implementation against said set of performance criteria;
e) identifying a second activity implementation for providing services to said first activity; and
f) if said first activity implementation fails to meet one or more of said performance criteria, then assigning said second activity implementation to said first activity in place of said first activity implementation.

2. A method according to claim 1 in which said workflow definition for said workflow is annotated so as to identify said set of performance criteria for said first activity implementation when providing services to said first activity.

3. A method according to claim 2 including the additional step of extending the replacement of the first activity implementation by said second activity implementation to one or more other managed workflow processes including said first activity implementation.

4. A method according to claim 3 in which a plurality of sets of performance criteria are determined for said first activity implementation, each said set relating to the performance of said activity implementation when providing services to a different activity.

5. A method according to claim 3 in which said second activity implementation is tested against said set of performance criteria prior to being assigned in place of said first activity implementation.

6. A method according to claim 3 in which said performance criteria are defined in a policy.

7. A method according to claim 6 in which said activity implementation are provided as a service by one or more service providers.

8. A method for managing a workflow in which said workflow comprises one or more business processes, the method comprising the steps of:
a) identifying a first service provider for providing services to one or more of said business processes and assigning a first service provider to one or more of said business processes;
b) determining a policy comprising of one or more performance criteria for services provided by said first service provider;
c) monitoring the performance of services provided by said first service provider against said policy;
d) identifying a second service provider for providing services to one or more of said business processes; and
e) if services provided by said first service provider fails to meet one or more of said performance criteria then assigning said second service provider to provide services to said given business process in place of said first service provider.

9. A method according to claim 8 including the additional step of extending the replacement of the first service provider by said second service provider to one or more other managed workflow processes to which the first service provider had been providing services.

10. Apparatus for managing a workflow process comprising one or more activities, said apparatus comprising:
workflow definition logic that defines a sequence of activities which comprise a workflow process;
assignment logic that identifies a first activity implementation for providing services to one or more of said activities and assigns said first activity implementations to a first said activity;
association logic that associates a set of one or more performance criteria for the performance of said first activity implementation when providing services to said first activity;
a performance monitor that monitor the performance of said first activity implementation against said set of performance criteria;
logic that identifies a second activity implementation for providing services to said first activity; and
replacement logic that assigns said second activity implementation to said first activity in place of said first activity implementation, if said first activity implementation fails to meet one or more of said performance criteria then.

11. An apparatus according to claim 10 wherein each activity implementation is provided by a service provider

12. An apparatus according to claim 11 wherein said replacement logic assigns a new service provider to provide the second activity implementation to replace the first activity implementation that had been provided by a different service provider.

13. A computer program for managing a workflow process comprising one or more activities, said computer program product comprising a machine usable medium embodying program instructions that when loaded into and executed by a computer causes the computer to perform a process comprising the steps of:
a) creating a workflow definition that defines a sequence of activities which comprise the workflow process;
b) identifying a first activity implementation for providing services to one or more of said activities and assigning said first activity implementation to a first said activity;
c) associating a set of one or more performance criteria for the performance of said first activity implementation when providing services to said first activity;
monitoring the performance of said first activity implementation against said set of performance criteria;
e) identifying a second activity implementation for providing services to said first activity; and
f) if said first activity implementation fails to meet one or more of said performance criteria, then assigning said second activity implementation to said first activity in place of said first activity implementation.

14. A computer program product according to claim 13 wherein the program instructions for creating the workflow definition further includes program instructions for annotating the workflow definition so as to identify said set of performance criteria for said first activity implementation when providing services to said first activity.

15. A computer program product according to claim 14 including additional program instructions that cause the computer to extend the replacement of the first activity implementation by said second activity implementation to one or more other managed workflow processes including said first activity implementation.

16. A computer program product according to claim 15 including program instructions for determining a plurality of set of performance criteria for said first activity implementation, each said set relating to the performance of said activity implementation when providing services to different activity.

17. A computer program product according to claim 14 including additional program instructions that result in said second activity implementation being tested against said set of performance criteria prior to being assigned in place of said first activity implementation.

18. A computer program product according to claim 14 in which said activity implementation are provided as a service by one or more service providers.

19. A computer program product for managing a workflow process comprising one or more activities, said computer program product comprising machine usable medium embodying program instructions that when loaded into and executed by a computer causes the computer to perform a process comprising the steps of:
a) identifying a first service provider for providing services to one or more of said business processes and assigning a first service provider to one or more of said business processes;
b) determining a policy comprising of one or more performance criteria for services provided by said first service provider;
c) monitoring the performance of services provided by said first service provider against said policy;
d) identifying a second service provider for providing services to one or more of said business processes; and
e) if services provided by said first service provider fails to meet one or more of said performance criteria then assigning said second service provider to provide services to said given business process in place of said first service provider.
